(19) United States
(12) Patent Application Publication
(10) Pub. No.: US 2013/0205312 A1
(43) Pub. Date: Aug. 8, 2013

(54) IMAGE DISPLAY DEVICE AND OPERATION METHOD THEREFOR

(71) Applicant: NOVATEK MICROELECTRONICS CORP., Hsinchu (TW)

(72) Inventor: Jiun-Wei Huang, Taipei City (TW)

(73) Assignee: NOVATEK MICROELECTRONICS CORP., Hsinchu (TW)

(21) Appl. No.: 13/678,068

(22) Filed: Nov. 15, 2012

Related U.S. Application Data
(60) Provisional application No. 61/595,001, filed on Feb. 3, 2012.

(30) Foreign Application Priority Data
Jul. 23, 2012 (TW) 101126486

(51) Int. Cl. H04N 21/482

(52) U.S. Cl. CPC H04N 21/482
USPC 725/11

(57) ABSTRACT

An operation method for an image display device includes: i) identifying a current user by detecting at least one of an image and a voice of the current user in response to a start-up command received by the image display device to generate a identification result; ii) accessing at least one favorite channel/program option associated with the current user according to the identification result; and iii) displaying the at least one favorite channel/program option on the image display device for the current user to select from.

This application claims the benefit of U.S. provisional application Ser. No. 61/595,001, filed Feb. 3, 2012, and the benefit of Taiwan application Serial No. 101126486, filed Jul. 23, 2012, the subject matters of which are incorporated herein by reference.

### TECHNICAL FIELD

The disclosure relates an image display device and an operation method therefor.

### BACKGROUND

Televisions are an indispensible necessity in a modern lifestyle for most people. With the continual development of the technology, in addition to watching television programs on a television, the number of applications executable on a television is also ever-increasing. As offered with diversified options when watching the television, television programs/television channels/applications favored by individuals may also be quite different.

In current situations, although an individual is allowed to control a television via a remote controller, such control means yet offers inadequate convenience. For example, each time a user turns on a television, a time-consuming process of sequentially browsing one channel after another in turn is needed before picking out a desired television program/channel. In some cases, a desired program may be skipped in the event of a commercial break and thus may not be timely picked. Alternatively, a user can only immediately select a desired channel/program given that the time and channel at which the desired program is broadcasted are in advance memorized by the user with extra effort. As the number of available channels or desired programs to select from grows, a user may not correctly remember the channels or the time at which the programs are broadcasted. The above difficulty is aggravated if a user has different preferences over different time periods. In other words, the conventional operation method of turning on a television and then selecting a desired channel/program through a remote controller falls short in providing adequate ease of use for a user to conveniently select and watch a desired television program and television channel.

### SUMMARY OF THE DISCLOSURE

The disclosure relates to an image display device and an operation method therefor, which in advance record programs/channels/applications of a user/a user group. Upon identifying a current user, the programs/channels/applications preferred by the current user are displayed.

The disclosure further relates to an image display device and an operation method therefor, which in advance record programs/channels/applications of a user/a user group. Upon identifying a current user, a preferred content (e.g., a program/channel) of the current user is selected from a database according to a current time and then automatically played.

An operation method for an image display device is provided by the present disclosure. The operation method includes: i) identifying a current user by detecting at least one of an image and a voice of the current user in response to a start-up command received by the image display device to generate a identification result; ii) accessing at least one favorite channel/program option associated with the current user according to the identification result; and iii) displaying the at least one favorite channel/program option on the image display device for the current user to select from.

An operation method for an image display device is further provided by the present disclosure. The operation method includes: i) identifying a current user by detecting at least one of an image and a voice of the current user in response to a start-up command received by the image display device to generate a identification result; ii) accessing at least one favorite channel/program/application option associated with the current user and a current time according to the identification result and the current time; and iii) playing or executing the at least one favorite channel/program/application option on the image display device.

An image display device is further provided by the present disclosure. The image display device includes: an identifying unit, for identifying a current user by detecting at least one of an image and a voice of the current user in response to a start-up command received by the image display device to generate an identification result; a storage unit, for storing at least one favorite channel/program option associated with the current user; a processing unit, coupled to the identifying unit and the storage unit, for accessing the at least one favorite channel/program option associated with the current user from the storage unit according to the identification result; and a display unit, coupled to the processing unit, controlled by the processing unit to display the at least one favorite channel/program option for the current user to select from.

An image display device is yet further provided by the present disclosure. The image display device includes: an identifying unit, for identifying a current user by detecting at least one of an image and a voice of the current user in response to a start-up command to generate an identification result; a storage unit, for storing at least one favorite channel/program/application option associated with the current user; a processing unit, coupled to the identifying unit and the storage unit, for accessing the at least one favorite channel/program/application option associated with the current user and a current time from the storage unit according to the identification result and the current time; and a display unit, coupled to the processing unit, controlled by the processing unit to play or execute the at least one favorite channel/program/application.

The above and other aspects of the disclosure will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an image display device according to an embodiment of the present disclosure.

FIG. 2 is a flowchart of an operation method for an image display device according to an embodiment of the present disclosure.

FIG. 3 is a flowchart of an operation method for an image display device according to another embodiment of the present disclosure.

FIG. 4 is a flowchart of an operation method for an image display device according to another embodiment of the present disclosure.

FIG. 5 is a flowchart of an operation method for an image display device according to another embodiment of the present disclosure.

FIG. 6 is an exemplary multi-grid arrangement according to an embodiment of the present disclosure.

FIG. 7 is a flowchart of an operation method for an image display device according to another embodiment of the present disclosure.

FIG. 8 is a flowchart of an operation method for an image display device according to another embodiment of the present disclosure.

FIG. 9 is a flowchart of an operation method for an image display device according to yet another embodiment of the present disclosure.

### DETAILED DESCRIPTION OF THE DISCLOSURE

Although programs/channels/applications favored by different users may be quite different, programs/channels/applications favored by one individual are fundamentally the same. Therefore, considering the above factor, in the embodiments, programs/channels/applications favored by individuals (e.g., members in a household) are recorded in advance. Thus, when a user turns on an image display device (e.g., a television), instead of going through a conventional time-consuming selection process via a remote controller or additionally memorizing the favorite programs/channels/applications in advance, a favorite program/channel/application desired by this user may be instantly selected/watched, thereby offering the user with a fun and convenient selection experience.

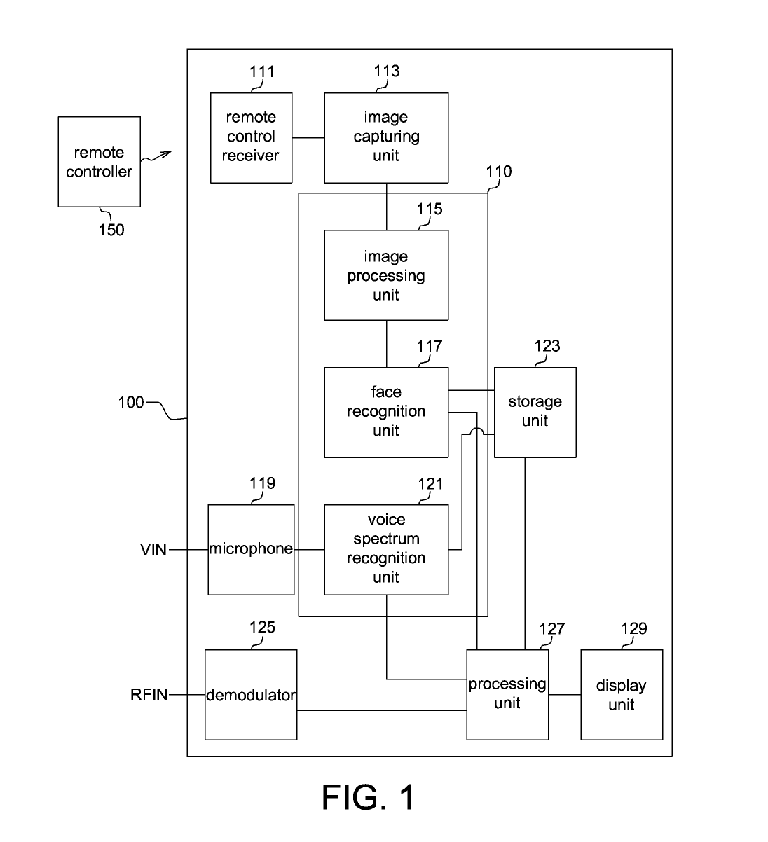

FIG. 1 shows a block diagram of an image display device 100 according to an embodiment of the present disclosure. For example, the image display device 100 is a television such as a common digital or analog television, a network television (e.g., Google TV or Apple TV), or another similar image display device. Further, the image display device may also be implemented by another type of device supporting image display, e.g., a desktop computer, a laptop/tablet computer, a smart phone, or other mobile communication devices.

As shown in FIG. 1, the image display device 100 includes an identifying unit 110, a storage unit 123, a processing unit 127 and a display unit 129. The image display device 100 may further include a remote control receiver 111, an image capturing unit (e.g., a lens) 113 and a microphone 119. The image display device 100 may further include a demodulator 125.

In response to a start-up command, the image display device 100 performs a start-up operation. In this embodiment, for example, a user may send the start-up command by: 1) sending a remote control start-up command by the remote controller 150 and receiving the remote control start-up command by the remote control receiver 111; 2) sending a wired control start-up command by a button (not shown); or 3) generating and receiving an audio start-up command by a user speaking to the microphone 119. That is, in an embodiment of the present disclosure, the start-up command may be a remote control start-up command, a wired control start-up command and/or an audio start-up command. In other embodiments, any other start-up command can also be implemented.

More specifically, the remote control receiver 111 receives a command sent from the remote controller 150. For example, the command is a remote control start-up command. When the user wishes to turn on the image display device 100, the remote controller 150 sends the remote control start-up command to the remote controller 111 in response to the user operation.

Further, the user may also operate the image display device 100 by a wired control approach. For example, the user may press or touch a power switch on the image display device 100 to turn on the image display device 100. That is to say, the image display device 100 may be powered on in response to a wired control start-up command initiated by the user.

The microphone 119 receives an audio signal VIN sent from the user. For example, the user may speak out an audio start-up command such as “turn on the television”. The audio start-up command is received by the microphone 119, and then the image display device 100 is powered on upon the image display device 100 detecting the audio start-up command. That is to say, the start-up command initiated by the user may include an audio start-up command.

The identifying unit 110 identifies a current user according to an image signal provided by the image capturing unit 113 and the audio signal sent by the microphone 119. In the embodiment in FIG. 1, for example, the identifying unit 110 includes an image processing unit 115, a face recognition unit 117 and a voice spectrum recognition unit 121. However, based on design requirements, the identifying unit 110 may perform audio recognition, image recognition, or both. An accuracy of an identification result usually gets higher when both audio recognition and image recognition are preformed. Therefore, in an alternative embodiment, the identifying unit 110 may include only the image processing unit 115, only the face recognition unit 117, or only the voice spectrum recognition unit 121. Moreover, the recognition unit 110 may further include other types of recognition units. Correspondingly, the image display device 100 may include only the image capturing unit 113 or the microphone 119.

Further, for example, the identifying unit 110 may be configured to become activated after the image display device 100 is turned on. Alternatively, the identifying unit 110 may be configured to become activated upon receiving a predetermined activation command.

More specifically, the image capturing unit 113 captures an image of the user, and may be coupled to the remote receiver 111. For example, after the image display device 100 receives the start-up command from the user via the remote controller 111, the image capturing unit 113 is activated to capture a face image of the user and to send the captured face image to the image processing unit 115.

The image processing unit 115, coupled to the image capturing unit 113, performs image processing on the user face image captured by the image capturing unit 113, and sends an image processing result to the face recognition unit 117. The face recognition unit 117, coupled to the processing unit 127, performs face recognition to identify an identification of the user, and sends a face recognition result to the processing unit 117. The face recognition unit 117 is coupled to the storage unit 123 to access face image data of a user group from a database to perform face recognition.

The microphone 119 is coupled to the voice spectrum recognition unit 121. The audio signal VIN received by the microphone 119 is sent to the voice spectrum recognition unit 121. The voice spectrum recognition unit 121 performs voice spectrum recognition on the audio signal received by the microphone 119 to identify the user. The voice spectrum recognition unit 121 is coupled to the storage unit 12 to access voice spectrum data of the user group from the database to perform voice spectrum recognition.

It should be noted that, the microphone 119 may be additionally coupled to the image capturing unit 113, such that the image capturing unit 113 may be jointly activated when the image display device 100 is turned on by the user voice through the microphone 119 (for example the user may speak out the audio start-up command such as “turn on the television” to turn on the image display device 100). The microphone 119 is implemented on the image display device 100 in FIG. 1, and may be alternatively implemented on the remote controller 150 in another embodiment of the present disclosure. Moreover, one or more start-up mechanisms can be realized, in combination with one or more identification mechanisms. For example, in a case where user voice is used for starting up the image display device 100, user voice can be used alone, or in addition with user image, in user identification.

The storage unit 123 is coupled to the processing unit 127, and stores one or multiple databases. The one or multiple databases may store a plurality of favorite channel/program/application options, identification data (e.g., the face image data and/or voice spectrum data), wherein data stored in the storage unit 123 is associated with at least one user and/or at least one user group.

In the database stored in the storage unit 123, the favorite channel/program/application options and the at least one user and/or the at least one user group may be stored in various association methods. For example, each user has personal data of favorite channel/program/application options. Further, one or more users may belong to the same user group, and the users in the user group may share the same favorite channel/program/application options.

Further, it should be noted that, apart from being associated with the user, the favorite channel/program/application options may also be associated with a time interval. The favorite channel/program/application options, the time intervals as well as the at least one user and/or the at least one user group may be stored in association methods. For example, each user or each user group may be associated with different channel/program/application options according to conditions of different time intervals. More specifically, each user or each user group is associated with a first set of channel/program/application options in a first time interval, associated with a second set of channel/program/application options in a second time interval, and so forth. According to design or user requirements, the time interval may be in a unit of minute(s), hour(s) or day(s).

Moreover, the one or multiple databases may be automatically or manually updated depending on actual requirements. When the image display device is implemented by a television, a channel/program/application option includes at least one favorite television channel, at least one favorite television program, or/and at least one favorite application (e.g., an application stored in a network television).

The user-associated favorite channel/program/application options may also include options of other types and forms. For example, apart from television programs, the user-associated favorite channel/program/application options may include video-on-demand (VOD). The channel/program/application options may also include link options, which prompt the image display device 100 to execute various corresponding operations, programs or commands when the link options are selected by the user.

The demodulator 125 demodulates the image signal VIN. For example, the image signal VIN is a television program signal.

The processing unit 127 is coupled to the face recognition unit 117, the voice spectrum recognition unit 121, the storage unit 123 and the demodulator 125. The processing unit 127 identifies a current user according to the face recognition result of the face recognition unit 117 and/or the voice spectrum recognition result of the voice spectrum recognition unit 121 to access from the storage unit 123 the favorite channel/program/application options associated with the identified user, and controls the control display unit 129 to display the corresponding favorite channel/program/application options for the current user to select from.

As previous described, according to the association between the user/user group and associated data stored in the storage unit 110, the user-associated favorite channel/program/application options may be different. For example, the favorite channel/program/application options associated with the current user may be at least one favorite channel/program option of the current user, or may be at least one favorite channel/program shared by members of the user group to which the current user belongs. Further, the processing unit 127 may also access only the favorite channel/program/application options associated with the current time and the current user. That is, when the current time falls within a predetermined time interval, the favorite channel/program/application options associated with the user (or the user group to which the current user belongs) under the predetermined time interval is accessed from the data base.

It should be noted that, before the processing unit 127 controls the display unit 129 to display the corresponding options, the processing unit 127 may perform a determination process to determine whether the user belongs to a predetermined user group. Only when a determination result is affirmative, the processing unit 127 accesses the favorite channel/program/application options associated with the user from the storage unit 123, and controls the display unit 129 to display the corresponding options for the user to select from. The above operations are not performed when the determination result is negative. Further, the predetermined group may include a part or the whole of a group or multiple groups stored in the storage unit 123. The options may be presented in a selection menu having a format configured according to design requirements.

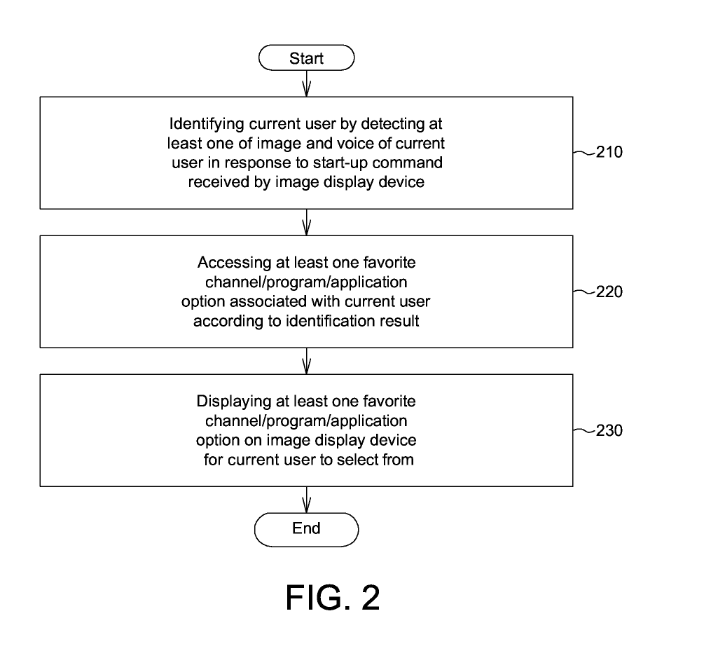

FIG. 2 shows a flowchart of an operation method for an image display device according to an embodiment of the present disclosure. With reference to FIG. 1 and FIG. 2, for example, the operation method may be applied to the image display device shown in FIG. 1.

Referring to FIG. 2, in Step 210, in response to a start-up command received by the image display device, a current user is identified by detecting at least one of an image and a voice of the current user. For example, as in the description associated with FIG. 1, user face recognition is performed by the image processing unit 115 and the face recognition unit 117, and/or user voice spectrum recognition is performed by the voice spectrum recognition unit 121.

In Step 220, according to an identification result obtained in Step 210, at least one favorite channel/program/application option associated with the current user is accessed. As in the description associated with FIG. 1, according to the face recognition result of the face recognition unit 117 and the voice spectrum recognition result of the voice spectrum recognition unit 121 as well as the recognition data stored in the storage unit 123, the processing unit 127 identifies the current user and then accesses the favorite channel/program/application options associated with the current user from the storage unit 123. As previously stated, the favorite channel/program application options associated with the current user may be at least one favorite channel/program option of the current user, or may be at least one favorite channel/program option shared by the members in the user group to which the current user belongs.

It should be noted that, in the determination process, the processing unit 127 further determines whether the current user belongs to a predetermined group (e.g., at least one existing user group) stored in the storage unit 123. Only when a determination result is affirmative, the processing unit 127 accesses the favorite channel/program/application options associated with the current user from the storage unit 123.

In Step 230, the favorite channel/program/application options are displayed on the image display device. As in the description associated with FIG. 1, the processing unit 127 may control the display unit 129 to display the favorite channel/program/application options accessed in Step 220 on the image display device 100 for the current user to select from. Thus, after the image display device receives a command corresponding to a selection result of the user, the channel, program or application selected by the user may be played or executed.

It should be noted that, the so-called favorite channel/program/application options in the steps in FIG. 2 may be one or multiple favorite channel options, favorite program options and favorite application options. For example, in an embodiment, the favorite channel/program/application options include favorite channel options and favorite program options but not favorite application options. In another embodiment, the favorite channel/program/application options include favorite channel options and favorite program applications as well as favorite application options.

Further, it should be noted that, in another embodiment, assuming that it is found that only one option is available after the current user is identified and the associated option is accessed, the favorite channel/program/application associated with the user may be directly played or executed without going through a user selection process.

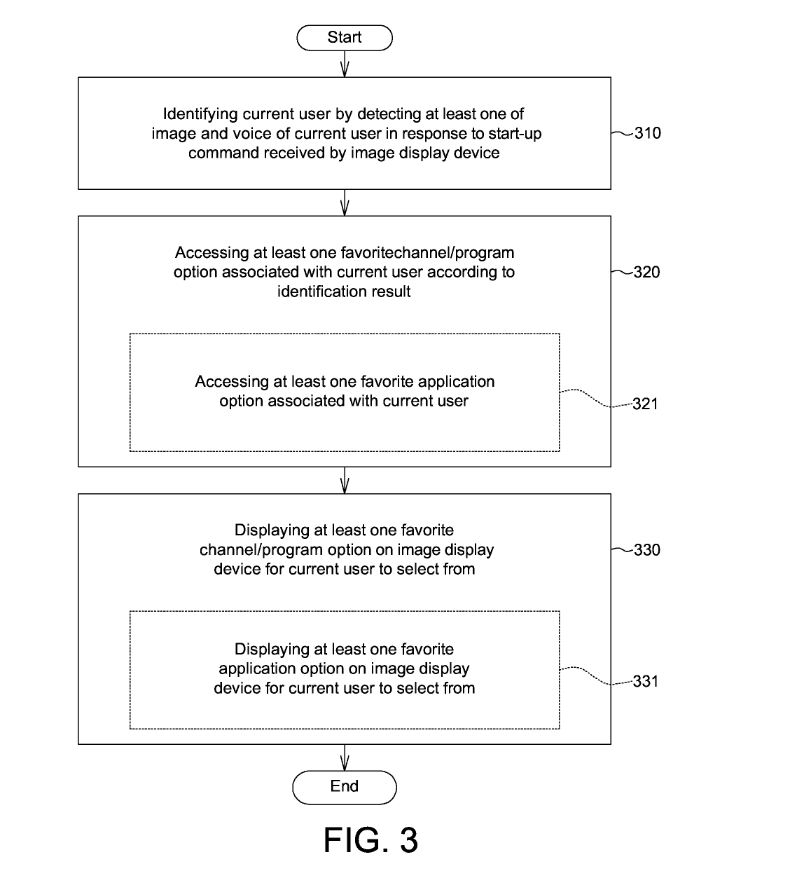

FIG. 3 shows a flowchart of an operation method for an image display device according to another embodiment of the present disclosure. For example, referring to FIGS. 1 and 3, the method in FIG. 3 may be applied to the image display device shown in FIG. 1 but is not limited thereto. Referring to FIG. 3, in Step 310, in response to a start-up command received by the image display device, a current user is identified by detecting at least one of an image and a voice of the current user. In Step 310, for example, the image processing unit 115 and the face recognition unit 117 perform user face recognition, and/or the voice spectrum recognition unit 121 performs voice spectrum recognition.

In Step 320, according to an identification result obtained in Step 310, at least one favorite channel/program option associated with the current user is accessed. Step 320 may further include Step 321. In Step 321, at least one favorite application option associated with the current user is accessed.

In Step 330, the at least one favorite channel/program option is displayed on the image display device for the current user to select from. Step 330 may further include Step 331. In Step 331, the at least one favorite application option is displayed on the image display device for the current user to select from.

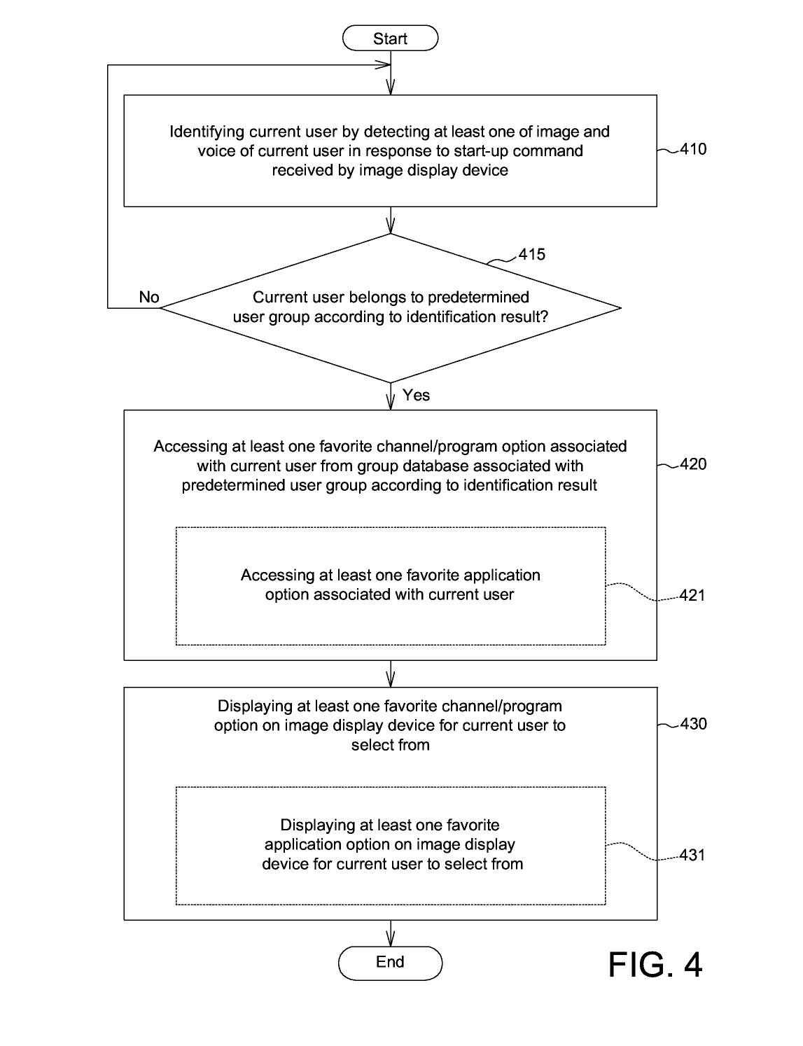

In another embodiment of the present disclosure, a user group determination process is added. When it is identified that the current user is not a member of a predetermined group stored in the storage unit 123, no option may be displayed on the image display device. FIG. 4 shows a flowchart of an operation method for an image display device according to yet another embodiment of the present disclosure. Referring to FIGS. 1 and 4, the method in FIG. 4 may be applied to the image display device shown in FIG. 1 but is not limited thereto.

In Step 410, in response to a start-up command received by the image display device, a current user is identified by detecting at least one of an image and a voice of the current user. Details of Step 410 may be similar to those of Step 310.

In Step 415, according to an identification result obtained in Step 410, it is determined whether the current user belongs to a predetermined user group. For example, in Step 415, the processing unit 127 determines whether the current user belongs to a predetermined user group according to the recognition result of the face recognition unit 117 and/or the recognition result of the voice spectrum recognition unit 121.

Step 420 is performed when a determination result of Step 415 is affirmative, or else the process returns to the beginning. In Step 420, according to the identification result, at least one favorite channel/program option associated with the current user is accessed from a group database associated with the predetermined user group. Details of Step 420 may be similar to those of Step 320. Similarly, Step 420 may further include Step 421. In Step 421, at least one favorite application option associated with the current user is accessed. Details of Step 421 may be similar to those of Step 321.

In Step 430, the at least one favorite channel/program option is displayed on the image display device for the current user to select from. Details of Step 430 may be similar to those of Step 330. Similarly, Step 430 further selectively includes Step 431. In Step 431, the at least one application option is displayed on the image display device for the current user to select from. Details of Step 431 may be similar to those of Step 331.

It should be noted that, multiple users may at the same time watch the television in certain cases. In another embodiment of the present disclosure, the multiple users are identified in the event that the multiple users at the same time watch the television, and the at least one favorite channel/program/application options associated with at least one of the multiple users is displayed according to the identification result.

In yet another embodiment, after the multiple users are identified, the favorite channel/program/application option(s) associated with each of the multiple users can be displayed. Further, as in the description associated with FIG. 4, it is respectively determined whether the multiple users belong to a predetermined user group, and the favorite channel/program/application options associated with one or multiple users that belong to the predetermined user group are displayed.

In yet another embodiment, before the favorite channel/program/application option(s) associated with at least one of the multiple users is(are) displayed, a user selection menu may be displayed for the users to select. For example, the user selection menu includes multiple user options, each corresponding to one of the identified users. The users may select one of the user selection menu (e.g., through a remote controller) to control the display 120 to display the channel/program options associated with the selected user.

Further, as in the description associated with FIG. 4, it is determined respectively whether the multiple users respectively belong to a predetermined user group. When the identification result and the determination result indicate that two or more users belong to the predetermined user group, a user selection menu is displayed on the display unit 129.

In another embodiment, in a situation of multiple users at the same time watching the television, one or more users among the multiple users may be identified according to determination conditions such as positions, distances or angles. For example, the user(s) located nearest to or within a distance range from the image display device, or the user(s) located nearest to a front center line or within an angle range of the image display device is/are identified, and the favorite channel/program/application option(s) associated with the identified user(s) can be displayed. Further, it may also be first determined whether the identified user(s) belong to a predetermined user group stored in the storage unit 123 before the associated option(s) is/are displayed.

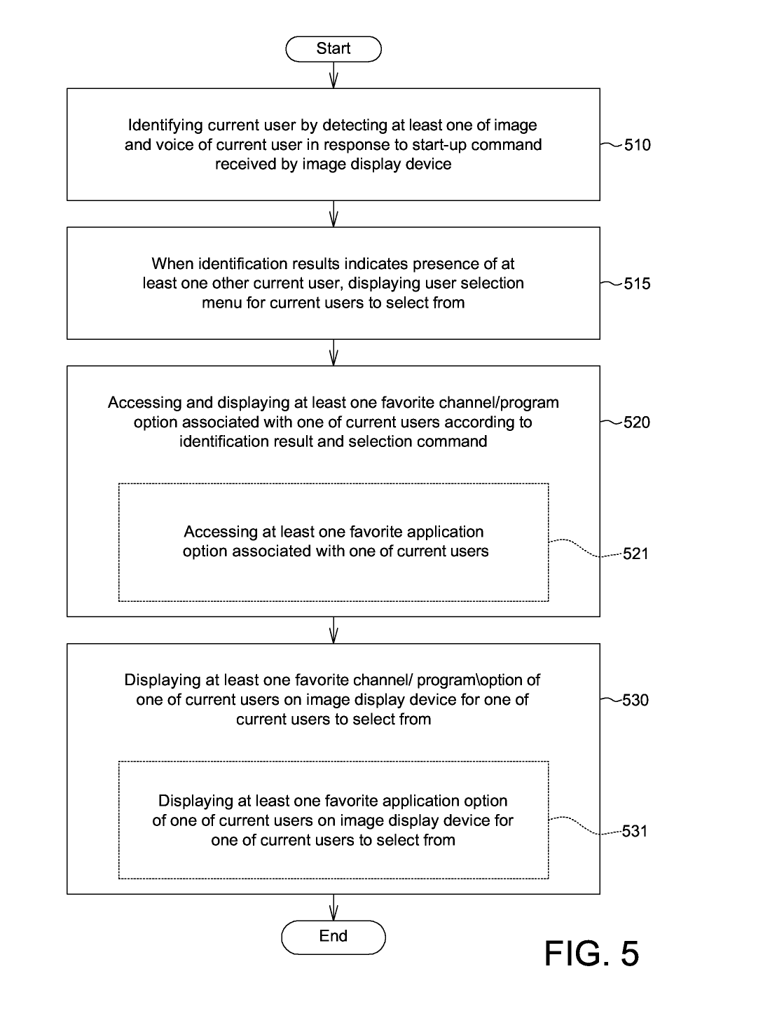

FIG. 5 shows a flowchart of an operation method for an image display device according to yet another embodiment of the present disclosure. Referring to FIGS. 1 and 5, the method in FIG. 5 may be applied to the image display device shown in FIG. 1 but is not limited thereto. In Step 510, in response to a start-up command received by the image display device, a current user is identified by detecting at least one of an image and a voice of the current user. Details of Step 510 may be similar to those of Step 310.

In Step 515, when an identification result obtained in Step S510 indicates that at least one other current user is present, a user selection menu is displayed for the current users to select from. For example, the processing unit 127 compares the database stored in the storage unit 123 according to the face recognition result of the face recognition unit 117 and/or the voice spectrum recognition result of the voice spectrum recognition unit 121. For example, the processing unit 127 controls the display unit 129 to display the user selection menu.

In Step 520, according to the identification result and a selection command, the favorite channel/program option(s) associated with one of the current users can be accessed. For example, when the current users select one user option in the user selection menu, in response to the selection command representing the user option, the processing unit 127 accesses the favorite channel/program option(s) associated with the selected user represented by the selected user option from the database in the storage unit 123.

Step 521 further selectively includes Step 521. In Step 521, at least one favorite application option associated with one of the current users is accessed. Details of Step 521 may be similar to those of Step 321.

In Step 530, at least one favorite channel/program option associated with one of the current users is displayed on the image display device for one of the current users to select from. Details of Step 530 are similar to those of Step 330. Step 530 further selectively includes Step 531. In Step 531, the at least one favorite application associated with one of the current users is displayed on the image display device for one of the current users to select from. Details of Step 531 are similar to those of Step 331.

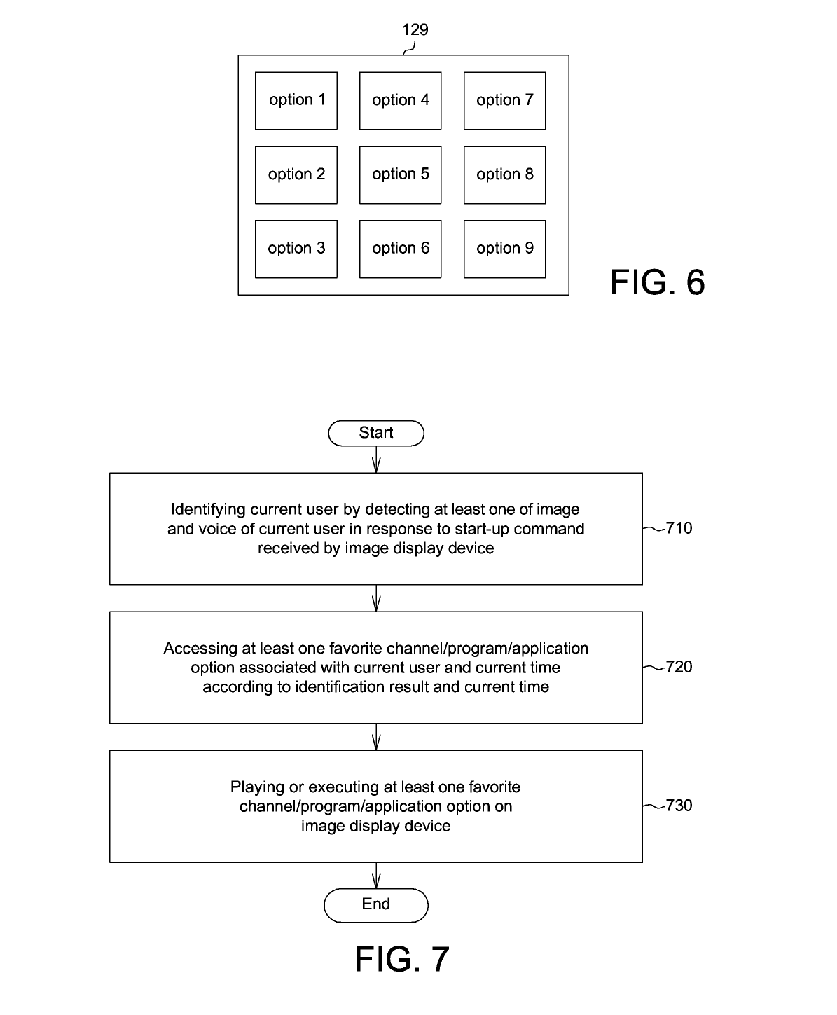

In the above embodiments, the favorite channel/program/application option(s) is(are) displayed in a multi-grid arrangement on the display unit 129 of the image display device 100. Referring to FIG. 6 showing an example of a multi-grid arrangement, multiple options (e.g., nine options from option 1 to option 9) can be displayed on the display unit 129. For example, each of the grids represent a graphic, text or animated picture of a corresponding option, or an image currently played by the channel or program, or any content according to design requirements. Thus, the user is allowed to intuitively select a desired option. Further, the number of the grids may be a constant number (e.g., three by three) or a flexible number for adapting to user preferences.

FIG. 7 shows a flowchart of an operation method for an image display device according to yet another embodiment of the present disclosure. Referring to FIGS. 1 and 7, in Step 710, in response to a start-up command received by the image display device, a current user is identified by detecting at least one of an image and a voice of the current user. Details of Step 710 may be similar to those of Step 310.

In Step 720, according to the identification result and a current time, at least one favorite channel/program/application option associated with the current user and the current time is accessed.

In Step 730, the at least one favorite channel/program/application option is displayed or executed on the image display device. Details of Step 730 may be similar to those of Step 330.

Exemplary details of Steps 720 and 730 are described below. For example, assume that a user A likes to watch a television channel 1 between seven to eight o′clock on Friday evenings, and likes to watch a television channel 2 or 3 or operate a predetermined application 4 between seven to eight o′clock on Saturday evenings. The above preferences are recorded in the database. For example, as the user A operates the image display device at seven-thirty on Saturday evening, when it is identified that the user A belongs to a predetermined user group, options corresponding to the television channels 2 and 3 as well as the application 4 as the favorite channel/program/application options are displayed.

In an alternative embodiment, assume that only one option as the favorite option of the user at the current time is available. The television channel 1 may be directly played without displaying the option for the user A to select a desired program. For example, when the current time is seven-thirty on Friday evening, the television directly plays the television channel 1 without requiring the user A to perform any subsequent manual operation after the user A sends out a start-up command. Further, in a situation of multiple users accepted/identified by the image display device are present, this embodiment can only implemented when the user A is one of the users watching the television. Further, in the event of multiple users, the above details of the user A as selected may be implemented after the user selection menu is displayed.

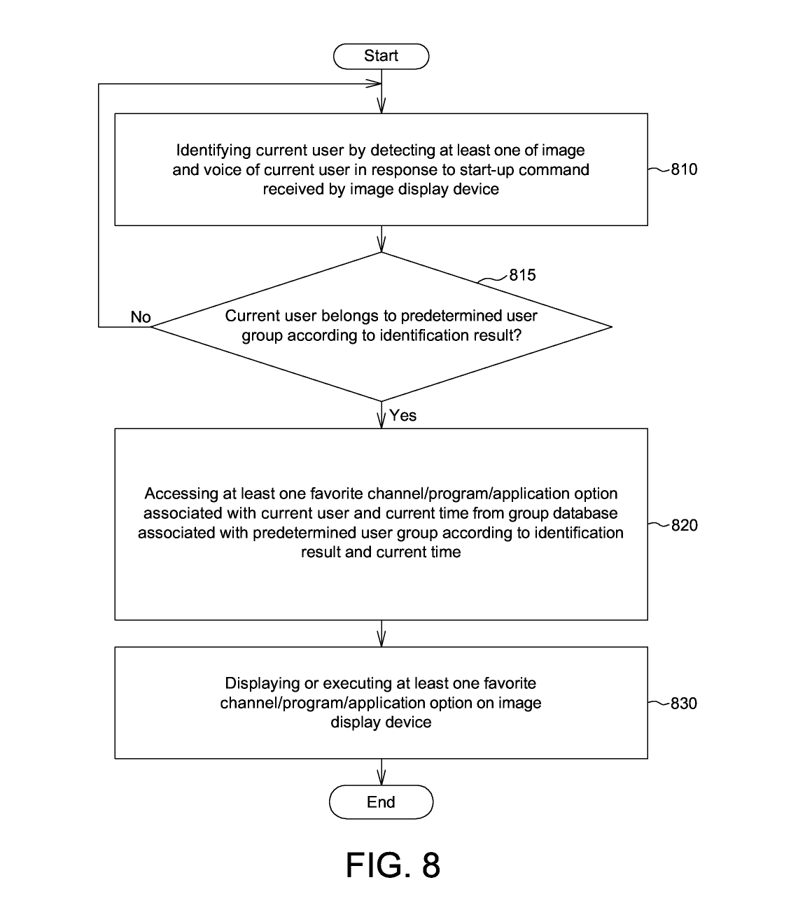

FIG. 8 shows a flowchart of an operation method for an image display device according to yet another embodiment of the present disclosure. Referring to FIGS. 1 and 8, in Step 810, in response to a start-up command received by the image display device, a current user is identified by detecting at least one of an image and a voice of the current user. Details of Step 810 may be similar to those of Step 310.

In Step 815, according to an identification result obtained in Step 810, it is determined whether the current user belongs to a predetermined user group. Details of Step 815 may be similar to those of Step 415.

In Step 820, according to the identification result and a current time, at least one favorite channel/program/application option associated with the current user and the current time is accessed from a group database associated with the predetermined user group. Details of Step 820 may be similar to those of Step 720.

In Step 830, the at least one favorite channel/program/application option is played or executed on the image display device. Details of Step 830 may be similar to those of Step 730.

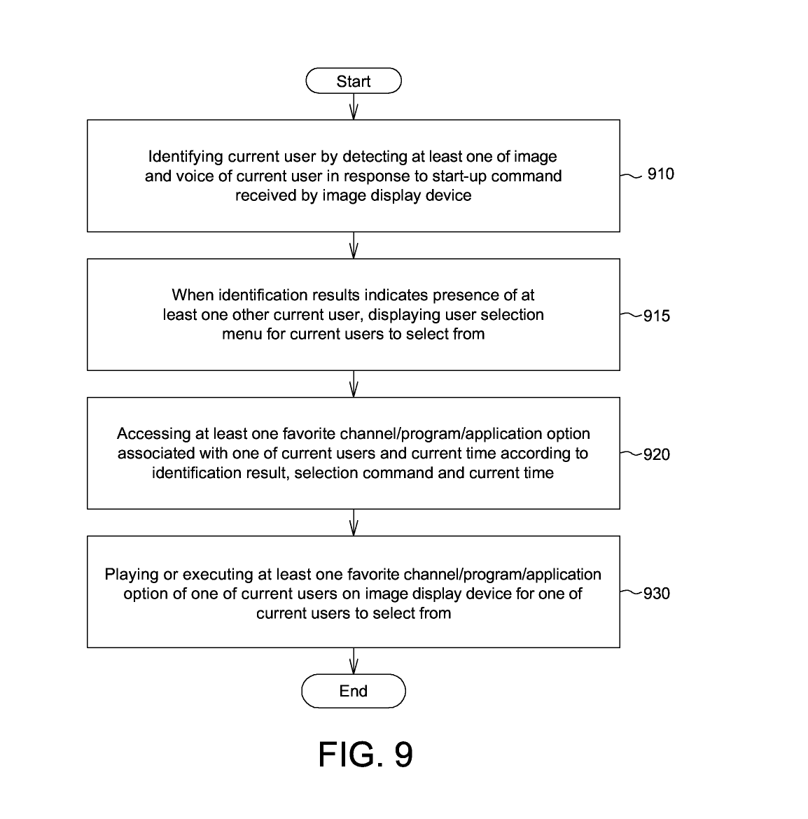

FIG. 9 shows a flowchart of an operation method for an image display device according to yet another embodiment of the present disclosure. Referring to FIGS. 1 and 9, in Step 910, in response to a start-up command received by the image display device, a current user is identified by detecting at least one of an image and a voice of the current user. Details of Step 910 may be similar to those of Step 710.

In Step 915, when an identification result obtained in Step 910 indicates that at least one other current user is present, a user selection menu is displayed for the current users to select from. Details of step 915 may be similar to those of Step 515.

In Step 920, according to the identification result, a selection command and a current time, at least one favorite channel/program/application option associated with the one of the current users and the current time is accessed. Details of Step 920 may be similar to those of Step 520.

In Step 930, the at least one favorite channel/program/application option of the one of the current users is played or executed for one of the current users to select from. Details of Step 930 are similar to those of Step 530.

Further, the above embodiments of the present disclosure may be combined without departing from the spirit of the present disclosure. For example, the embodiments in FIGS. 4 and 5 may be combined, or the embodiments in FIGS. 8 and 9 may be combined, as such modifications are within the scope of the present disclosure.

In the present disclosure, the processing unit 127, the image processing unit 115, the face recognition unit 117, and/or the voice spectrum recognition unit 121 may be implemented by hardware and/or software.

In addition to presetting the database, the database may be automatically set or updated through other approaches. For example, the database may be automatically updated by accumulating user watching times or time intervals, and/or user selection times. Thus, the favorite channel/program/application options associated with users stored in the database are allowed to better adapt to user preferences and to increase updating convenience of the database. Moreover, the favorite channel/program/application options may also include an option that has been watched/selected by the current user, or an option that the current user previously watched for a predetermined period of time. The favorite channel/program/application options may further include an option that the current user previously watched for once or several times within a same time interval (e.g., between seven to eight on Saturday evenings), or an option that the current user previously watched for a predetermined period of time within a same time interval.

Further, the term “favorite” channel/program/application options are used to refer to the options displayed. However, it should be noted that these options do not necessarily match user likes or preferences, and may include options preset through other approaches. For example, the favorite channel/program/application options may additionally include or rather include only “limited” channel/program/application options. For example, under certain circumstances, options that can be watched or operated by children under a certain age are selected and restricted by guardians. In other words, the disclosure may cover all possible preset channel/program/application options associated with users.

In the above embodiments, a start-up command is taken as an example. In other embodiments, other operation commands or system commands may be utilized substitutively or additionally based on design requirements. For example, to identify another joining user in an event that the previous user leaves during viewing, a command may be executed to again perform the identification and play functions. In other words, the implementation of image/voice recognition is not limited to be performed only once after the start-up process, and/or the channel/program/application options are not limited to being immediately displayed after the recognition.

While the disclosure has been described by way of example and in terms of the preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An operation method for an image display device, comprising:
i) identifying a current user by detecting at least one of an image and a voice of the current user in response to a start-up command received by the image display device to generate an identification result;
ii) accessing at least one favorite channel/program option associated with the current user according to the identification result; and
iii) displaying the at least one favorite channel/program option on the image display device for the current user to select from.

2. The operation method according to claim 1, wherein step (ii) further comprises accessing at least one favorite application option associated with the current user; and step (iii) further comprises displaying the at least one favorite application option on the image display device for the current user to select from.

3. The operation method according to claim 1, wherein the image display device is a television, a desktop computer, a laptop computer, a tablet computer, or a mobile communication device.

4. The operation method according to claim 1, wherein the start-up command is at least one of an audio start-up command, a remote control start-up command and a wired control start-up command.

5. The operation method according to claim 1, wherein step (i) comprises:
activating an image capturing unit in response to a remote control start-up command; and
activating face recognition.

6. The operation method according to claim 1, wherein step (i) comprises:
activating voice spectrum recognition in response to an audio start-up command from a microphone.

7. The operation method according to claim 1, further comprising:
determining whether the current user belongs to a predetermined user group according to the identification result to generate a determination result; and
determining whether to perform step (ii) according to the determination result.

8. The operation method according to claim 7, wherein the step of determining whether to perform step (ii) according to the determination result comprises:
when the determination result is affirmative, performing step (ii) from a group database associated with the predetermined user group; and
when the determination result is negative, omitting step (ii).

9. The operation method according to claim 1, wherein step (ii) comprises:
determining whether the current user belongs to one of a plurality of existing user groups according to the determination result; and
accessing at least one favorite channel/program option shared by members of the determined existing user group to serve as the at least one favorite channel/program option associated with the current user.

10. The operation method according to claim 1, wherein step (ii) comprises:
determining whether the current user is one of a plurality of existing users according to the identification result; and
accessing at least one favorite channel/program option associated with the determined existing user to serve as the at least one favorite channel/program option associated with the current user.

11. The operation method according to claim 1, further comprising:
when the identification result indicates at least one other current user is present, displaying a user selection menu for the current users to select from; and
accessing and displaying the at least one favorite channel/program options associated with one of the current users in steps (ii) and (iii) according to a selection command.

12. The operation method according to claim 1, wherein in step (ii), the at least one favorite channel/program option associated with the current user and a current time is accessed according to the current time.

13. The operation method according to claim 1, wherein in step (iii), the at least one favorite channel/program option is displayed in a multi-grid arrangement on the image display device.

14. An operation method for an image display device, comprising:
i) identifying a current user by detecting at least one of an image and a voice of the current user in response to a start-up command received by the image display device to generate an identification result;
ii) accessing at least one favorite channel/program/application option associated with the current user and a current time according to the identification result and the current time; and
iii) displaying or executing the at least one favorite channel/program/application option on the image display device for the current user to select from.

15. The operation method according to claim 14, wherein the start-up command is at least one of an audio start-up command, a remote control start-up command and a wired control start-up command.

16. The operation method according to claim 14, wherein step (i) comprises:
activating an image capturing unit in response to a remote control start-up command; and
activating face recognition.

17. The operation method according to claim 14, wherein step (i) comprises:
activating voice spectrum recognition in response to an audio start-up command from a microphone.

18. The operation method according to claim 14, wherein the image display device is a television, a desktop computer, a laptop computer, a tablet computer, or a mobile communication device.

19. The operation method according to claim 14, further comprising:
determining whether the current user belongs to a predetermined user group according to the identification result to generate a determination result; and
determining whether to perform step (ii) according to the determination result.

20. The operation method according to claim 19, wherein the step of determining whether to perform step (ii) according to the determination result comprises:
when the determination result is affirmative, performing step (ii) from a group database associated with the predetermined user group; and
when the determination result is negative, omitting step (ii).

21. The operation method according to claim 14, wherein step (ii) comprises:
determining whether the current user belongs to one of a plurality of existing user groups according to the determination result; and
accessing at least one favorite channel/program/application option associated with the determined existing user group and the current time to serve as the at least one favorite channel/program option associated with the current user.

22. The operation method according to claim 14, wherein step (ii) comprises:
determining whether the current user is one of a plurality of existing users according to the determination result; and
accessing at least one favorite channel/program/application option associated with the determined existing user and the current time to serve as the at least one favorite channel/program/application option associated with the current user.

23. The operation method according to claim 14, further comprising:
when the identification result indicates at least one other current user is present, displaying a user selection menu for the current users to select from; and
accessing and displaying the at least one favorite channel/program/application options associated with one of the current users in steps (i) and (ii) according to a selection command.

24. The operation method according to claim 14, wherein in step (iii), the at least one favorite channel/program option is displayed in a multi-grid arrangement on the image display device.

25. An image display device, comprising:
an identifying unit, for identifying a current user by detecting at least one of an image and a voice of the current user in response to a start-up command received by the image display device to generate an identification result;
a storage unit, for storing at least one favorite channel/program option associated with the current user;
a processing unit, coupled to the identifying unit and the storage unit, for accessing the at least one favorite channel/program option associated with the current user from the storage unit according to the identification result; and
a display unit, coupled to the processing unit, controlled by the processing unit to display the at least one favorite channel/program option for the current user to select from.

26. The image display device according to claim 25, wherein the processing unit accesses the at least one favorite channel/program option associated with the current user from the storage unit, and further controls the display unit to display the at least one favorite channel/program option on the image display device for the current user to select from.

27. The image display device according to claim 25, wherein the image display device is a television, a desktop computer, a laptop computer, a tablet computer, or a mobile communication device.

28. The image display device according to claim 25, wherein the start-up command is at least one of an audio start-up command, a remote control start-up command and a wired control start-up command.

29. The image display device according to claim 25, further comprising:
an image capturing unit;
wherein, in response to a remote control start-up command, the image capturing unit is activated, and the identifying unit activates face recognition.

30. The image display device according to claim 25, further comprising:
a microphone;
wherein, in response to an audio start-up command from the microphone, the identifying unit activates voice spectrum recognition.

31. The image display device according to claim 25, wherein the processing unit determines whether the current user belongs to a predetermined user group according to the identification result to generate a determination result, and determines whether to access the at least one favorite channel/program option from the storage unit according to the determination result.

32. The image display device according to claim 31, wherein the processing unit accesses the at least one favorite channel/program option from a group database associated with the predetermined user group stored in the storage unit when the determination result is affirmative, and does not access the at least one favorite channel/program option when the determination result is negative.

33. The image display device according to claim 25, wherein the processing unit determines whether the current user belongs to one of a plurality of existing user groups according to the determination result, and accesses at least one favorite channel/program option associated with the determined existing user group from the storage unit to serve as the at least one favorite channel/program option associated with the current user.

34. The image display device according to claim 25, wherein the processing unit determines whether the current user is one of a plurality of existing users according to the determination result, and accesses at least one favorite channel/program option associated with the determined existing user from the storage unit to serve as the at least one favorite channel/program option associated with the current user.

35. The image display device according to claim 25, wherein the at least one favorite channel/program option comprises at least one favorite television channel and/or at least one favorite television program.

36. The image display device according to claim 25, wherein when the identification result indicates at least one other current user is present, a user selection menu is displayed on the display unit for the current users to select from; and the processing unit determines, accesses and displays the at least one favorite channel/program option associated with one of the current users on the display unit according to a selection command.

37. The image display device according to claim 25, wherein the processing unit accesses the at least one favorite channel/program option associated with the current user and a current time further according to the current time.

38. The image display device according to claim 25, wherein the display unit displays the least one favorite channel/program option in a multi-grid arrangement.

39. An image display device, comprising:
an identifying unit, for identifying a current user by detecting at least one of an image and a voice of the current user in response to a start-up command received by the image display device to generate an identification result;
a storage unit, for storing at least one favorite channel/program/application option associated with the current user;
a processing unit, coupled to the identifying unit and the storage unit, for accessing the at least one favorite channel/program/application option associated with the current user and a current time from the storage unit according to the identification result and the current time; and
a display unit, coupled to the processing unit, controlled by the processing unit to display or execute the at least one favorite channel/program/application option.

40. The image display device according to claim 39, wherein the start-up command is at least one of an audio start-up command, a remote control start-up command and a wired control start-up command.

41. The image display device according to claim 39, further comprising:
an image capturing unit;
wherein, in response to a remote control start-up command, the image capturing unit is activated, and the identifying unit activates face recognition.

42. The image display device according to claim 39, further comprising:
a microphone;
wherein, in response to an audio start-up command from the microphone, the identifying unit activates voice spectrum recognition.

43. The image display device according to claim 39, wherein the image display device is a television, a desktop computer, a laptop computer, a tablet computer, or a mobile communication device.

44. The image display device according to claim 39, wherein the processing unit determines whether the current user belongs to a predetermined user group according to the identification result to generate a determination result, and determines whether to access the at least one favorite channel/program/application option from the storage unit according to the determination result.

45. The image display device according to claim 44, wherein the processing unit accesses the at least one favorite channel/program/application option from a group database associated with the predetermined user group stored the storage unit when the determination result is affirmative, and does not access the at least one favorite channel/program/application option when the determination result is negative.

46. The image display device according to claim 39, wherein the processing unit determines whether the current user belongs to one of a plurality of existing user groups according to the determination result, and accesses at least one favorite channel/program/application option associated with the determined existing user group and the current time from the storage unit to serve as the at least one favorite channel/program/application option associated with the current user.

47. The image display device according to claim 39, wherein the processing unit determines whether the current user is one of a plurality of existing users according to the determination result, and accesses at least one favorite channel/program/application option associated with the determined existing user and the current time from the storage unit to serve as the at least one favorite channel/program/application option associated with the current user.

48. The image display device according to claim 39, wherein the at least one favorite channel/program/application option comprises at least one favorite television channel and/or at least one favorite television program.

49. The image display device according to claim 39, wherein when the identification result indicates at least one other current user is present, a user selection menu is displayed on the display unit; and the processing unit determines, accesses and displays the at least one favorite channel/program/application option of one of the current users on the display unit according to a selection command.

50. The image display device according to claim 39, wherein the display unit displays the least one favorite channel/program option in a multi-grid arrangement.
